(19) United States
(12) Patent Application Publication
(10) Pub. No.: US 2008/0288536 A1
(43) Pub. Date: Nov. 20, 2008

(54) Method and System for Integrating Browsing Histories with Media Playlists

(75) Inventors: Silvia Pfeiffer, Gladesville (AU); Andre Pang, New South Wales (AU); Conrad Parker, New South Wales (AU)

Correspondence Address: MERCHANT & GOULD PC, P.O. BOX 2903, MINNEAPOLIS, MN, 55402-0903, US

(73) Assignee: Commonwealth Scientific and Industrial Research Organisation, Campbell (AU)

(21) Appl. No.: 11/658,216

(22) PCT Filed: Jul. 21, 2005
(86) PCT No.: PCT/AU2005/001068

§ 371 Date: May 29, 2008

(30) Foreign Application Priority Data
Jul. 23, 2004 (AU) 2004904123

(51) Int. Cl. G06F 17/30

(52) U.S. Cl. 707/104.1; 707/E17.009

(57) ABSTRACT

A method for maintaining a media playlist (100) and a browsing history list of a media browsing session on a media playback device. The media playlist (100) includes a reference to at least one media document available for playback on the device, and a playlist pointer (112) identifying a currently-playing media document in the playlist (100). The browsing history list includes references to zero or more content documents previously accessed in the media browsing session. Responsive to termination of playback of a first media document and loading for playback of a second media document on the media playback device, the method includes the steps of updating the playlist pointer (112) to identify the second media document as the currently-playing media document, and updating the browsing history list to include a reference to the first media document as the most recently accessed content document. The method provides a user of a media playback device with access to a playlist, as commonly provided with media players, as well as a history list, as commonly provided with web browsers, which are integrated in a consistent manner to facilitate efficient and intuitive media browsing. A corresponding media playback device and software product are also provided.

### FIELD OF THE INVENTION

The present invention relates to methods and apparatus for browsing media documents, especially media documents made available via distributed information networks such as the World Wide Web.

### BACKGROUND OF THE INVENTION

The World Wide Web has evolved into the de facto standard for distributed information retrieval. The combination of an open networking standard (the Hypertext Transfer Protocol, HTTP), global resource identifiers (Universal Resource Locators, URL, or Universal Resource Identifiers, URI), and a simple mark-up language for text documents (Hypertext Mark-up Language, HTML) have enabled a platform for building a highly cohesive and connected information network. Most commonly, a user interface for accessing and browsing the World Wide Web is provided by a web browser software application, exemplified by products such as Microsoft Internet Explorer, Firefox (based on the earlier Netscape Navigator browser) and the Opera web browser.

At the same time, improved sound and graphics capability of personal computing devices, along with wider availability of broadband internet connections, have resulted in increases in the distribution and use of continuous streaming media, such as audio and video.

Within this specification, the term “documents” is used generally to refer to a variety of types of content that may be rendered for viewing, playback or interactive operation by a user, for example through the use of a web browser, a media player, or other suitable software applications and/or hardware devices. The word “documents” therefore generally encompasses substantially static documents, such as text, HTML, word-processing, Portable Document Format (PDF) and other types of static-content documents. More dynamic forms of document include Dynamic HTML (DHTML) and other forms of scripted or animated content, including documents playable by applications such as the commercially available Flash Player. Media documents include such items as streaming audio and video, as well as self-contained audio and video files. It will be appreciated that all of these forms of electronic documents, as well as other types well known in the art, may be delivered and stored in various forms, including streaming over the internet for rendering in real-time, and storage as files in computer memory and/or on magnetic or optical storage media. Such documents may be complete and self-contained, for continuous rendering from beginning to end, or may be delivered and/or stored in an incomplete form, such as where only a selected portion, such as a section of a larger audio document, or a scene from a movie or other larger video file, is provided to a user in streaming and/or downloadable form.

While most web browser applications support extensions, plug-ins and/or interfaces with other software applications for playing individual media documents, more general management and playback of multiple media documents is typically performed using a media player application. Such media player applications are exemplified by Microsoft Windows Media Player, Apple's iTunes, and Real Networks' RealPlayer Product.

As will be appreciated by the many users of web browser and media player applications, there are a number of significant differences between the user models, and corresponding user interfaces, of web browsers and media players. Use of the World Wide Web is based on a browsing model, resulting from the prevalence of HTML, which in turn enables web-based documents to contain hyperlinks leading a user to other, typically related, documents on the World Wide Web. As well as enabling the user to follow hyperlinks, the browsing model conventionally includes a browsing history, in which the most recently viewed documents can be retrieved through the operation by the user of interface elements, such as graphical buttons or control keys “back” and “forwards”. As the access patterns of users interacting with hyperlinked resources have been found to have a high degree of recurrence, a user interface that enables access to recently viewed resources is recommended for usable navigation.

The dominant paradigm amongst media player applications, on the other hand, is the playlist. As the name suggests, a playlist is a list, queue or sequence of media documents. A playlist may be, for example, the ordered track listing of a music album, or a series of scenes or sequences making up a television program or movie. Most media player applications also allow users to create custom playlists, for example selections of their favorite musical items, or of audio and/or video items having a common theme. While playlists may be used for many purposes, the features that all playlists have in common are that they group together media documents which have, at least from a user's perspective, something in common to motivate the grouping, and/or they define a particular order or sequence in which the media documents are typically to be played back. In normal modes of operation, a media player application will play each media document in a playlist in turn, automatically commencing playback of a subsequent media document once a currently playing document has completed. This remains the case even when the media player application is operating in a random or “shuffle” mode, so as to play the media documents in a randomised order, rather than the sequence defined by the playlist.

At least in part, a reason for the different user models employed by web browsers and media players is that, until recently, there was no mark-up language equivalent to HTML to enable hyperlinking from continuous media documents. Accordingly, continuous media have not previously conformed to the user model of browsing that the Web promotes. To address this limitation, mark-up languages for media documents and other time continuous resources are under development, such as the Continuous Media Mark-up Language (CMML) developed by the present inventors. CMML provides hyperlinks and metadata, and can be embedded into media documents, thereby effectively “web-enabling” them. It thus extends the Web's browsing paradigm to include media documents, making them first-class, active citizens on the Web.

Accordingly, it is anticipated that new webs of media resources will emerge, thus requiring the development of a media browser to enable users to “surf” media documents in a manner analogous to the existing web-browsing paradigm. Current media players typically do not support hyperlinks and browser-like navigation in their user interface or internal architecture, and a first step for supporting browsable media is to display the hyperlinks on screen, and to make them active (ie “clickable”). However, this then raises the question of how activating a hyperlink from the current media document interacts with a media player's playlist.

An alternative approach to adding browsable media support to a media player may be to add the capabilities of a media player to a web browser. However, once it is appreciated that it would be desirable to provide playlists as web resources (ie playlists provided as downloadable, linkable document objects from web servers), it becomes unclear how such playlists should interact with the web browser's history.

As will be appreciated from the foregoing discussion, simply extending a media player or a web browser application in the most readily apparent manner does not entirely satisfy a user's requirements for a media browser application. In particular, it is rather cumbersome to require the user to mentally switch between the two user interface paradigms of the playlist and the browsing history, when they wish to accomplish the same goals in both types of applications. From a user's perspective, browsing through a history, and navigating through a playlist, should preferably be seamlessly integrated operations providing maximum convenience for accessing documents visited in the past (through the history), or documents queued for future playback (eg via a playlist).

Accordingly, there is a need, in implementing a media browser, to resolve the different paradigms of web browsing and media playback by integrating playlist and history list functionality to provide a usable user interface, which provides a consistent user experience. For example, a user of a media browser may expect that activating the “back” button returns them to the previously viewed media document. The user may also reasonably expect that the “up” and “down” user interface elements of a playlist should move them through a queue of media documents that they have arranged for playback in a particular order. The user may also wish to be able to directly select any of the items in either their browsing history or playlist, without disturbing their browsing or playlist expectations.

It is accordingly an object of the present invention to address the need to integrate playlists and browsing history in a media browser.

It will be appreciated that any discussion of documents, devices, acts or knowledge in this specification is included to explain the context of the invention, and should not be taken as an admission that any of this material formed part of the prior art base or the common general knowledge in the relevant art on or before the priority date of any of the statements herein, or the claims appended hereto.

### SUMMARY OF THE INVENTION

In one aspect, the present invention provides a method for maintaining a media playlist and a browsing history list of a media browsing session on a media playback device, the media playlist including a reference to at least one media document available for playback on the device and a playlist pointer identifying a currently-playing media document in the playlist, and the browsing history list including references to zero or more content documents previously accessed in the media browsing session, the method including the steps of, responsive to termination of playback of a first media document and loading for playback of a second media document on the media playback device:

updating the playlist pointer to identify the second media document as the currently-playing media document; and

updating the browsing history list to include a reference to the first media document as the most recently accessed content document.

The invention thus recognises that playlists and browsing history are orthogonal approaches to representing documents available for playback, and that the user wishes to have access to both approaches depending upon their media browsing needs.

The invention, in its various embodiments, therefore may provide both the browsing history actions (eg “back” and “forward”) and the playlist navigation actions (eg “up” and “down”) for use by the user, and may present these as separate entities. The present inventors have recognised that the difference between a playlist and a browsing history is that the playlist is a queue of items to be looked at in the future, which provides a continuity of experience, whereas the browsing history is a list of items visited in the past, and provides rapid access to previous experiences. In the case of the playlist, by explicitly sequencing items the user is asking the application to view particular media items when the previous item has finished playing. On the other hand, a history list is constructed on the basis of actions taken by the user during browsing.

Since these two paradigms are substantially orthogonal, performing complementary functions from the user's perspective, it is highly desirable, and possible, to offer both to the user. According to preferred embodiments of the invention, user interaction with the playlist results in update of the browsing history stack where appropriate, and browsing actions, such as moving back and forward in the browsing history, should result in corresponding changes to the item currently playing in the playlist.

Accordingly, an advantage provided by the present invention is the linking of the playlist with the history list to provide the user with access to both paradigms, while ensuring consistency between them by performing corresponding updates when the currently-playing media document changes.

The media playback device may be a personal computer running media browsing software configured to implement the method of the invention. However, it will be appreciated by those skilled in the art that portable digital media players are becoming increasingly popular, including portable or handheld PCs as well as devices dedicated primarily to media playback. Additionally, portable and handheld devices, incorporating wireless telephony and data transfer functionality, are increasingly also provided with a variety of additional capabilities, including web browsing, email, and media playback. It is therefore to be understood that the term “media playback device” is intended to encompass all such devices known in the art that are suitable for media playback.

The termination of playback of the first media document and loading for playback of the second media document may be a result of the first media document playing to completion, wherein the second media document is the next media document referenced in the playlist. Advantageously, the automatic advancement of playback through the playlist (ie the normal function of a playlist) results in corresponding updates to the history list, thereby ensuring a consistent user experience.

Alternatively, termination of playback of the first media document and loading for playback of the second media document may be a result of the user selecting a new media document from the playlist, wherein the second media document is the new media document selected by the user. Again, the normal, and familiar, use of the playlist in this manner advantageously results in corresponding appropriate updates to the history list.

At least the first media document may be web-enabled using, for example, a mark-up language such as CMML, such that the first media document includes at least one embedded mark-up element providing an active link to the second media document, and termination of playback of the first media document and loading for playback of the second media document may be a result of the user activating said link. Preferably, the embedded mark-up element is a CMML mark-up element, and the mark-up element preferably includes a hyperlink.

As will be appreciated, for web-enabled media documents the user's mental model of the action of activating the embedded link is most likely based upon the common web browsing experience, rather than the conventional media player experience.

Accordingly, the addition of the “linked from” document to the history list would appear natural to the user. Again, however, methods according to preferred embodiments of the present invention provide the advantage that a corresponding update to the currently-playing item in the playlist ensures continuity of the user experience by maintaining consistency between the playlist and the history list.

Preferably, if the playlist does not include a reference to the second media document, then the step of updating the playlist pointer includes adding a reference to the second media document to the playlist.

In a particularly preferred embodiment, the playlist is a recursive playlist, including a hierarchy of sub-lists in which each sub-list is associated with a parent media document at the next higher level of the hierarchy. The first media document may include at least one embedded mark-up element providing an active link to a server-side playlist including a reference to the second media document, and, responsive to the user activating said link, the step of updating the playlist pointer includes the sub-steps of:

adding the server-side playlist to the hierarchy as a sub-list associated with the first media document; and

updating the playlist pointer to identify said second media document referenced in the server-side playlist.

In this situation, the second media document may be the first document in the server-side playlist. Alternatively, the second media document may be a media document in the server-side playlist that is identified in the embedded mark-up element providing the link to the server-side playlist. Advantageously, this arrangement enables a hyperlink to a server-side playlist to reference any document in the server-side playlist, playback of which will commence following download of the server-side playlist.

It is particularly preferred that server-side playlists be treated as immutable, to ensure consistency of the user's browsing experience, since it is typically not possible for a user to modify a server-side playlist on the server. However, actions which modify a playlist may be allowed on the top level playlist, and may result either from direct user operations to add, delete or otherwise modify items in the playlist, and/or actions taken by the user in the course of the media browsing session.

In preferred embodiments, termination of playback of a first media document and loading for playback of a second media document may be a result of the user requesting playback of the previous media document in the media browsing session, and the method of maintaining a media playlist and a browsing history may further include, responsive to said user request, the steps of:

retrieving a reference to the first media document from the browsing history list; and

updating the playlist pointer to identify the first media document as the currently playing media document. As will be appreciated, this behaviour is consistent with the functionality expected by the user of the “back” button in a conventional web browser.

Preferably, the references to said first and second media documents each include one of a URI or a URL.

The media browsing session of the user may include repeatedly updating the playlist pointer and updating the browsing history list responsive to termination of playback of a first media document and loading for playback of a second media document, and/or retrieving a reference from the browsing history list and updating the playlist pointer responsive to the user requesting playback of the previous media document in the media browsing session. That is, embodiments of the present invention preferably provide a media browsing session that is analogous to a conventional web browsing session as implemented through a typical web browser application.

In another aspect, the present invention provides a media playback device for playing media documents in a media browsing session, the device including:

a media playlist including a reference to at least one media document available for playback on the device and a playlist pointer identifying a currently-playing media document in the playlist;

a browsing history list including references to zero or more content documents previously accessed in the media browsing session;

means for maintaining the media playlist; and

means for maintaining the browsing history list,

wherein said maintaining means are configured to, in response to termination of playback of a first media document and loading for playback of a second media document, update the playlist pointer to identify the second media document as the currently-playing media document, and update the browsing history list to include a reference to the first media document as the most recently accessed content document.

The media playback device may be, for example, a desktop or portable personal computer running suitable media browsing software, or may alternatively be a portable digital media player dedicated primarily to media playback, or other portable or handheld device with additional functionality such as wireless telephony and/or data transfer. Typically, the media playback device will include an audio output interface, including electronic circuitry suitable for generating and amplifying audio signals, as well as speakers and/or headphone sockets or similar. The device will also typically include a video output interface, including circuitry for generating a video signal as well as a display device, such as an LCD display or a CRT display. Preferably, the media playback device also includes one more user input devices, such as a keyboard, mouse, touch-screen, and/or other buttons or controls suitable for providing input to the device.

The means for maintaining the media playlist and the browsing history preferably include one or more software components executing on at least one central processing unit of the media playback device, including executable instructions to effect the functions of maintaining the media playlist and the browsing history.

Termination of playback of the first media document and loading for playback of the second media document may be a result of the first media document playing to completion, wherein the second media document is the next media document referenced in the playlist.

In preferred embodiments, the media playback device includes a playlist display having a list of media documents included in the playlist, and means to enable a user to select a new media document from the playlist, and thereby to terminate playback of the first media document and load the new media document selected by the user as the second media document. The means for a user to select a new media document from the playlist preferably includes one or more input devices of the playback device and one or more software components executing on the central processing unit of the device including executable instructions to effect the detection of user input and selection of the new media document from the playlist. For example, the user may employ an input device such as a mouse to highlight and activate the selected media document in the playlist. According to a conventional user interface model, selection may include the user double clicking with a mouse.

Preferably, the means for selecting a new media document from the playlist also includes the provision of “next” and “previous” controls, in accordance with the corresponding user interface features typically provided in media player applications.

In a particularly preferred embodiment, the first media document may include at least one embedded mark-up element providing an active link to the second media document, and the media playback device includes a media display configured to enable a user to select and activate the active link, to terminate playback of the first media document and load the second media document for playback. The embedded mark-up element is preferably a CMML mark-up element, and the active link is preferably a hyperlink. The hyperlink may be displayed on the media display during playback as a clickable region of the display, which may be either permanently or temporarily available during playback of the first media document.

In the event that the playlist does not include a reference to the second media document, the means for maintaining the media playlist is preferably configured to add a reference to the second media document to the playlist.

In a preferred embodiment, the playlist is a recursive playlist, including a hierarchy of sub-lists in which each sub-list is associated with a parent media document at the next higher level of the hierarchy, and the playlist display of the media playback device includes a hierarchical playlist display in which each sub-list is visually associated with its parent media document in the form of a collapsible list to enable a user to select whether or nor the sub-list is visible in the playlist display. Advantageously, the sequence of media documents played by the media playback device during continuous playback corresponds with the visible document listing in the hierarchical playlist display. Accordingly, in preferred embodiments of the invention the user is able to determine, by selectively expanding or collapsing each sub-list, whether media documents included in the sub-lists are played in sequence during continuous playback of the playlist document, or alternatively whether only the higher level parent documents are played. Operation of the “next” and “previous” functions of the media playback device is preferably also consistent with the hierarchical playlist display.

Typically, the history list is implemented as a stack, and the means for maintaining the history list is configured to update the browsing history list to include a reference to the first media document by pushing a reference to the first media document onto the stack.

The maintaining means are preferably also configured to enable the user to request playback of the previous media document in the media browsing session and, responsive to the request, to retrieve a reference to the first media document from the browsing history list, and to update the playlist pointer to identify the first media document as the currently-playing media document. Preferably, the user request is received through the activation of a user interface control such as a “back” button. Where the history list is implemented as a stack, as is preferred, the step of retrieving a reference to the first media document from the browsing history list includes popping the reference back off the stack.

In another aspect, the invention also encompasses a computer program product including computer-executable instruction code which, when executed on a media playback device, causes the device to effect the steps of a method in accordance with embodiments of the invention. In some embodiments, the computer-executable instruction code may be provided as an extension or plug-in to a standard web browser to add media browsing functionality. Alternatively, the computer executable instruction code may be adapted to execute on a portable or handheld device, such as a PDA, pocket PC, digital audio player, wireless telephony handset or the like, to cause said portable or handheld device to effect the steps of a method in accordance with embodiments of the invention.

In yet another aspect, the invention provides a media playback device including a media browser having a media playlist which includes a reference to at least one media document available for playback on the device, and a browsing history list including references to zero or more content documents,

wherein the media browser is configured, responsive to browsing and playback activity of a user during a media browsing session, to perform integrated updates of the media playlist and browsing history list such that the user is provided with a consistent media browsing and playback experience.

The media browser preferably includes a first pair of complementary user controls for navigating the media playlist, and a second pair of complementary user controls for navigating the browsing history list, whereby the media browser is configured to perform integrated updates of the media playlist and browsing history list responsive to activation by the user of one or more of said user controls. In particularly preferred embodiments, the first pair of complementary user controls includes “next” and “previous” controls, and the second pair of complementary user controls includes “forward” and “back” controls.

The media document available for playback on the device may include a media document having embedded metadata elements which may mark, for example, the beginning of segments of media, such as audio passages or video segments or scenes, within the media document. Such embedded metadata elements may be provided, for example, in media documents formatted according to the Annodex format.

Further preferred features and advantages of the present invention will be apparent to those skilled in the art from the following description of a preferred embodiment of the invention, which should not be considered to be limiting of the scope of the invention as defined in any of the preceding statements, or in the claims appended hereto.

Preferred embodiments of the invention are described with reference to the accompanying drawings.

### BRIEF DESCRIPTION OF THE DRAWINGS

FIG. 1 illustrates a process of browsing within a playlist in accordance with an embodiment of the invention;

FIG. 2 illustrates a process of accessing a playlist within a browsing activity in accordance with an embodiment of the invention;

FIG. 3 illustrates a process of browsing to a server-side playlist in accordance with an embodiment of the invention;

FIG. 4 shows an expanded recursive playlist in accordance with an embodiment of the invention; and

FIG. 5 shows a collapsed recursive playlist in accordance with an embodiment of the invention.

### DETAILED DESCRIPTION OF PREFERRED EMBODIMENTS

The present invention is directed to the implementation of a media browser, which is a software-enabled device, or an executable software application for use on general-purpose computing hardware, for providing integrated playback and browsing of web-enabled media documents. Web-enabled media documents include media having embedded mark-up elements providing active links to other media, or alternative types of content documents. Such embedded mark-up elements may be provided, for example, using the Continuous Media Mark-up Language (CMML), which provides hyperlinks and metadata which may be embedded into media documents. It will be appreciated, however, that a typical web browsing session may include accessing a variety of different types of content document, including HTML documents and conventional media documents which do not include embedded mark-up elements. Accordingly, embodiments of the present invention are able to work with a number of different types of media and other content documents.

In implementing a media browser, one approach is to start with an application design that users are familiar with, and extend the application to provide the additional functionality required for media browsing. Accordingly, one possible approach is to extend a media player application to include web browser functionality, or alternatively to extend a web browser application to provide the functionality of a media player. Media players employ the concept of a media playlist for organising media resources for playback, while web browsers employ a browsing history for maintaining a navigable record of a user's browsing activities.

In accordance with preferred embodiments of the invention, the two concepts of a media playlist and a browsing history are retained and integrated within a media browser. For example, it is considered desirable for a user to be able to navigate their browsing history using familiar interface elements, such as “back” and “forward” buttons and also to be able to navigate a play list using equally familiar media player controls such as “up” and “down” buttons.

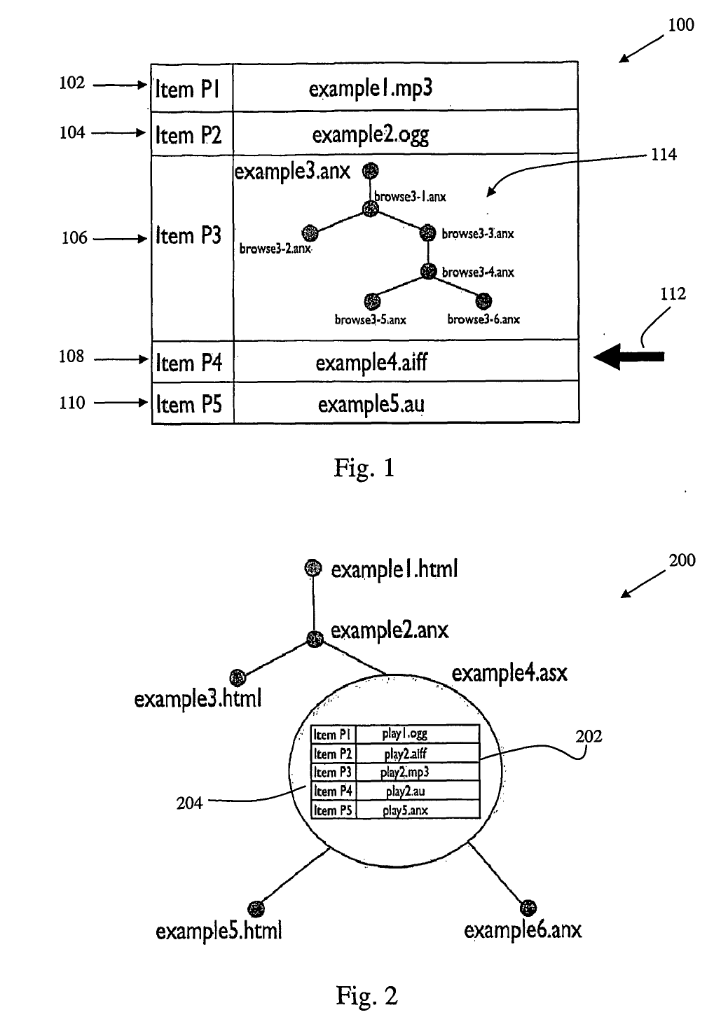

FIG. 1 illustrates schematically the actions involved in browsing media resources within a playlist 100. The exemplary playlist 100 includes five playlist items 102, 104, 106, 108, 110. Each playlist item includes a reference to a media document available for playback by the media browser application. The reference is typically a suitable identifier of the media document, such as a file name, or more preferably a Universal Resource Locater (URL) or Universal Resource Identifier (URI). For example, playlist item 102 includes a reference to the media document example1.mp3. Similarly playlist item 104 includes a reference to media document example2.ogg, playlist item 108 includes a reference to media document example4.aiff, and playlist item 110 includes a reference to media document example5.au. The media documents referenced by playlist items 102, 104, 108, 110 are all continuous media documents that do not include embedded mark-up elements, and which therefore cannot form the basis for a browsing activity by a user of the media browser application.

However, playlist item 106 references media document example3.anx, which is a web-enabled media document. As illustrated by the browsing tree 114, the file example3.anx enables the user to browse to other, similarly web-enabled, media documents. In the example shown in FIG. 1, the user browsed to browse3-1.anx, and thereafter to browse3-2.anx, browsed back in the history stack (to browse3-1.anx), thereafter browsing to browse3-3.anx, then browse3-4.anx, then browse3-5.anx, back to browse3-4.anx, and eventually finishing at browse3-6.anx. Thereafter, the user allowed the document browse3-6.anx to finish playing, resulting in the media browser application moving on to play the document referenced by playlist item 108, example4.aiff. As indicated in FIG. 1, the media playlist 100 also includes a playlist pointer 112, identifying the currently-playing media document in the playlist, which following the activities described in the foregoing is playlist item 108.

According to preferred embodiments of the invention, web-enabled media documents are provided in the Annodex format, and such files may be created using CMML. Within this specification, Annodex format media documents have file names with a .anx extension. Corresponding loadable playlists, eg server-side playlists, use the filename extension .asx. Annodex formatted files may include embedded metadata elements which mark the beginning of the determined segments of media content, such as audio passages or video scenes, within a media document. Accordingly, one advantage of such annotated media documents is the ability to initiate playback, or browse directly to, such internally marked segments of the media document. Furthermore, a single media document may be represented as a playlist which provides direct access to each individual segment, passage or scene within the document.

In accordance with embodiments of the invention, the browsing history 114 is regarded as a separate playlist item. When a user activates a hyperlink within a document referenced by a particular playlist item, the reference to the original item is replaced with the browsing history. Accordingly, in the example described above the original playlist item referenced the media document example3.anx, which was replaced with browsing history 114 when the user first browsed to browse3-1.anx.

As exemplified in the playlist 100 the entire history stack is displayed in the user interface as a large playlist item. Alternative implementations, such as displaying only the first or last item in the history stack, would limit access to intermediary items in the history stack to the use of the “back” button. In accordance with the usual usage paradigm of a media player, each item in the history stack should be directly selectable from the playlist interface.

Preferred embodiments of the invention also provide the user with navigation function conventionally associated with a web browser. The browsing history is the fundamental navigational principle of a web browser, and familiar browser functions, such as following hyperlinks, typing URIs directly into the address bar, and going back and forward through the browser history, must continue to operate in accordance with users' expectations. Web-enabled media documents may be supported in a web browser via a plug-in, or extension software module, however once media playback is made available, a media browser embodying the invention should also be able to play back media playlists. Such playlists may be provided, for example, as objects served from web servers, ie server-side playlists. The question therefore arises of how such playlists should be treated by such a media browser.

In preferred embodiments of the invention, server-side playlists are treated as immutable resources, ie no editing is permitted on a playlist, in contrast to the typical functionality of a media player. FIG. 2 illustrates a browsing activity 200, wherein the user has at one point browsed to an immutable playlist 202, named example4.asx. In the exemplary activity 200, after browsing to the immutable playlist 202, the browser plays back the media files of the playlist in sequence, in accordance with conventional media player functionality. In the example 200 shown in FIG. 2, the playlist 202 includes an item 204 having a reference to a web-enabled media document play5.anx. This enables the user to follow hyperlinks embedded in the web-enabled media document, for example allowing the user to navigate outside of the playlist, to example5.html or example6.anx.

In its various embodiments, the present invention integrates the browsing history and the media playlist. In particular, from the user's perspective at least, browsing hyperlinked resources with the aid of a history list represents a different paradigm to playing media documents through the use of a media playlist. Accordingly, it is preferable that the media browser application's user interface supports these two, substantially orthogonal, paradigms of use.

A preferred implementation is therefore based on the guiding principle that any time a new media document is loaded, which may occur when activating a hyperlink, double-clicking on a different file in the playlist, or even moving on to the next playlist item as the previous one finishes, the previously viewed media document should be added to the browsing history, for example by pushing a reference to the document onto the browsing history stack.

More particularly, when playback of a first media document is terminated and a second media document is loaded for playback into the media browser, the playlist pointer should be updated to identify the second media document as the currently-playing media document, and the browsing history list should be updated to include a reference to the first media document as the most-recently-accessed content document.

If the new (ie second) media document is loaded as a result of the user activating a hyperlink, then it may well be the case that the second media document is not included in the current playlist. Accordingly, in these circumstances, and according to preferred embodiments of the invention, a reference to the second media document is automatically added to the playlist, and the playlist pointer updated to point to the newly added document.

Returning now to FIG. 1, in accordance with this integrated approach for maintaining the media playlist and the browsing history in the media browser, following the actions described with reference to FIG. 1 the history list would contain the following references (listed in order from most recently accessed media document to the earliest accessed media document): browse3-6.anx; browse3-4.anx; browse3-3.anx; browse3-1.anx; example3.anx; example2.ogg; example1.mp3. The currently-playing document, indicated by playlist pointer 112 is example4.aiff, and following termination of playback of this document, a reference to the document will be pushed onto the history list stack and playback of item 110, example5.au, will commence.

Similarly, the history list corresponding with the browsing activity 200 previously described with reference to FIG. 2 may be determined. In this case, assuming that the currently-playing media document is example6.anx, the history list includes (again from most recent to earliest accessed): play5.anx; play2.au; play2.mp3; play2.aiff; play1.ogg; example4.asx; example2.anx; example1.html. All of the media documents accessed during the browsing activity would also appear in the playlist, providing the user with an alternative means of proceeding directly to any of these media documents.

The example browsing activity 200 illustrated in FIG. 2, however, highlights a further issue that must be addressed in order to fully integrate the browsing history and playlist user interface paradigms. Specifically, since it is possible for the user to browse to a server-side playlist, it is necessary that such a playlist be presented in the user interface in a consistent and convenient manner.

One option available to users in preferred embodiments is to treat a loaded playlist, such as a server-side playlist, as a separate entity and open a new window in the media browser for the user to interact with the new playlist. Such behaviour is clearly analogous to opening a document referenced by a hyperlink in a new window in a web browser. However, this first option disconnects the new playlist from the original playlist, and the new window is opened with an empty browsing history stack, just as in conventional web browser implementations. Accordingly, although the user's previous browsing experiences are retained in the history stack of the original window, this history remains associated only with the original playlist, and cannot be accessed from the new playlist window.

Accordingly, particularly preferred embodiments of the invention also provide recursive playlists, wherein loaded playlists, such as server-side playlists, are displayed as items within the original playlist. More specifically, a recursive playlist includes a hierarchy of sub-lists, in which each sub-list is associated with a parent media document at the next higher level of the hierarchy. Generally, the parent media document of a sub-playlist is the document containing the server-side playlist, referenced by a link which was followed by the user.

Since users generally will not have permission to modify, or upload, playlists to a server (and such modification may, in any case, affect the browsing experience of other users), it is preferable that loaded playlists be treated as immutable playlists by the media browser. Actions which modify a playlist, such as adding or deleting a playlist item, are restricted to operate on the top-level playlist only. Logically, the top-level playlist is the only playlist whose content is defined by the user, and thus this is the only playlist which should be considered mutable. This restriction ensures that operations which modify a playlist exhibit consistent behaviour, whereby only the top-level playlist is modified.

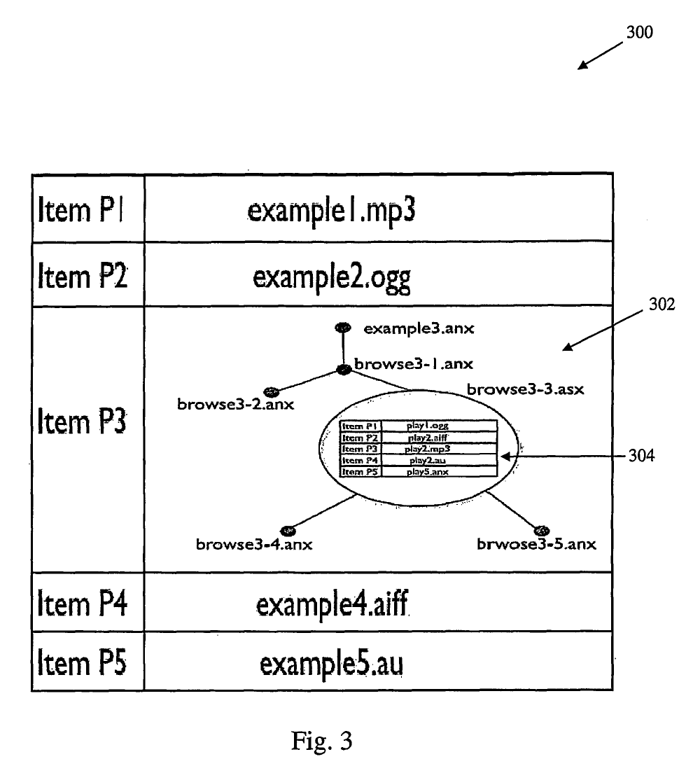

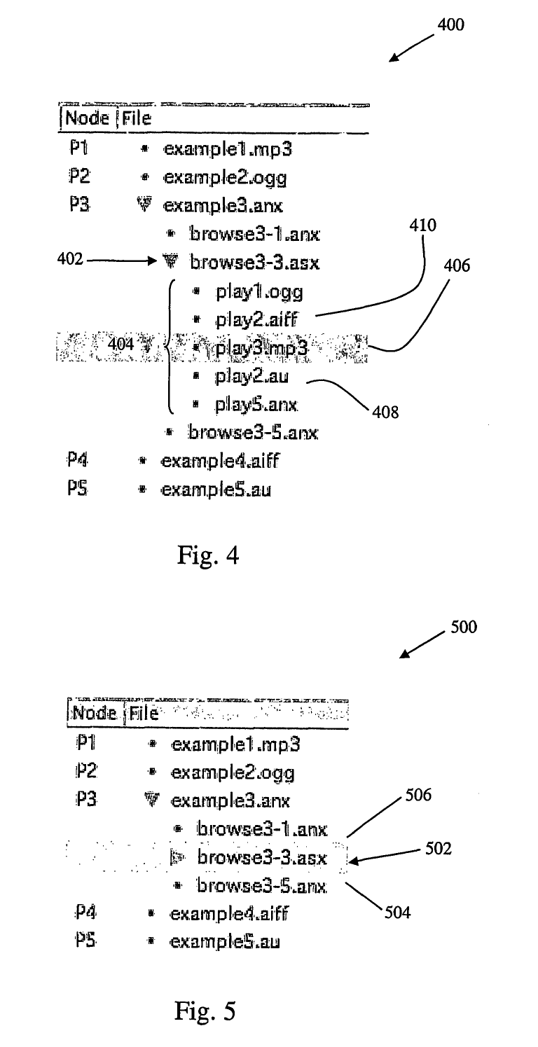

FIG. 3 shows a playlist 300 including a browsing activity 302 illustrating the process of browsing to a server-side playlist 304 in accordance with a preferred embodiment of the invention. FIGS. 4 and 5 show corresponding hierarchical playlist displays. In the course of browsing activity 302, the user browses from browse3-1.anx to browse3-3.asx which includes server-side playlist 304. The server-side playlist 304 is loaded by the media browser as an immutable playlist, and displayed as a sub-list 404 associated with the parent media document 402, namely browse3-3.asx, within the playlist display 400.

The playlist 400 includes a playlist pointer identifying the currently-playing document within the playlist. As indicated in FIG. 4, the current location of the playlist pointer within the recursive playlist 400 is indicated by shading of the corresponding playlist item. In the example, the media document 406, entitled play3.mp3, is the currently-playing document. According to the preferred user interface model, the user may interact with the expanded recursive playlist 400 using the normal playlist operations. For example, the “up” operation will result in media document 410, entitled play2.aiff, commencing playback. Similarly, the “down” operation will result in media document 408, entitled play2.au, being played. Accordingly, the expanded recursive playlist provides the user with a familiar and intuitive interface to the media browser.

Furthermore, according to preferred embodiments of the invention, playlist items in a recursive playlist are collapsible. This is illustrated in FIG. 5, wherein a collapsed recursive playlist 500 is shown, corresponding with the expanded playlist 400 in FIG. 4. The playlist item 502 (browse3-3.asx) has been collapsed, such that the sub-list items 404, corresponding with server-side playlist 304, are no longer visible in the playlist 500. This results in an intuitive alteration in the behaviour of the normal playlist user interface elements. That is, the “up” operation results in the selection and playback of the visibly preceding media document 506, namely browser3-1.anx, while the “down” operation results in the playback of the visibly succeeding media document 504, namely browser3-5.anx.

There may be circumstances in which a playlist loaded as a result of a user browsing activity is editable by the user. For example, a loaded playlist may be contained in a file on the user's local computer, or may be on a web server to which the user has write-access. However, consistent with the model that only the top-level playlist may be modified by the user, the media browser preferably offers the capability of opening the loaded playlist as another top-level, mutable, playlist, in a separate window. Following browsing and/or media playing activities which result in changes to the top-level playlist, the user may be subsequently offered the option to save the modified playlist back to the source file or web server.

As a further option, immutable, server-side playlists may be saved locally and subsequently opened in a new top-level window if desired. However, the default behaviour for loaded playlists should be to present them as an item in the top-level playlist, so that the user's browsing experience is not interrupted.

From the foregoing description, it will be readily apparent to those skilled in the art that many variations of the method, apparatus and software components for maintaining a media playlist and a browsing history within a media browser are possible in accordance with the invention, which is not to be limited to the particular embodiments described. For example, it will be understood that while preferred forms of user interface have been described, other forms of graphical interface may be provided if desired. Furthermore, while preferred embodiments have generally been described with reference to a media browser implemented as a software application executing on a personal computer with a windows-style graphical user interface, other forms of media browser applications and devices are possible. For example, a media browser may be implemented on a portable media playback device, using a correspondingly simplified user interface. Other variations, modifications and equivalent will also be apparent to personal of skill in the art, and will be understood also to forward in the scope of the present invention.

1. A method for maintaining a media playlist and a browsing history list of a media browsing session on a media playback device, the media playlist including a reference to at least one media document available for playback on the device and a playlist pointer identifying a currently-playing media document in the playlist, and the browsing history list including references to zero or more content documents previously accessed in the media browsing session, the method including the steps of, responsive to termination of playback of a first media document and loading for playback of a second media document on the media playback device:
updating the playlist pointer to identify the second media document as the currently-playing media document; and
updating the browsing history list to include a reference to the first media document as the most recently accessed content document.

2. A method according to claim 1 wherein termination of playback of the first media document and loading for playback of the second media document is a result of the first media document playing to completion, wherein the second media document is the next media document referenced in the playlist.

3. A method according to claim 1 wherein termination of playback of the first media document and loading for playback of the second media document is a result of a user selecting a new media document from the playlist, wherein the second media document is the new media document selected by the user.

4. A method according to claim 1 wherein the first media document includes at least one embedded mark-up element proving an active link to the second media document, and termination of playback of the first media document and loading for playback of the second media document is a result of a user activating said link.

5. A method according to claim 4 wherein the embedded mark-up element is a Continuous Media Mark-up Language (CMML) mark-up element.

6. A method according to claim 4 wherein the mark-up element includes a hyperlink.

7. A method according to claim 1 wherein, in the event that the playlist does not include a reference to the second media document, the step of updating the playlist pointer includes adding a reference to the second media document to the playlist.

8. A method according to claim 1 wherein the playlist is a recursive playlist including a hierarchy of sub-lists in which each sub-list is associated with a parent media document at the next higher level of the hierarchy.

9. A method according to claim 8 wherein the first media document includes at least one embedded mark-up element providing an active link to a second playlist that includes a reference to the second media document and, responsive to a user activating said link, the step of updating the playlist pointer includes the sub-steps of:
adding the second playlist to the hierarchy as a sub-list associated with the first media document; and
updating the playlist pointer to identify said second media document referenced in the second playlist.

10. A method according to claim 9 wherein the second media document is the first document referenced in the second playlist.

11. A method according to claim 9 wherein the second media document is a media document in the second playlist that is identified in the embedded mark-up element providing the link to the second playlist.

12. A method according to claim 1 wherein termination of playback of the first media document and loading for playback of the second media document is a result of a user requesting playback of a previous media document in the media browsing session, and the method includes, responsive to said user request, the further steps of:
retrieving a reference to the first media document from the browsing history list; and
updating the playlist pointer to identify the first media document as the currently playing media document.

13. A method according to claim 1 wherein said references to the first and second media documents each include one of a URI or a URL.

14. A method of a user conducting a media browsing session on a media playback device that includes a media playlist and a browsing history list, the media playlist including a reference to at least one media document available for playback on the device and a playlist pointer identifying a currently-playing media document in the playlist, and the browsing history list including references to zero or more content documents previously accessed in the media browsing session, the method including repeatedly performing the steps of, responsive to termination of playback of a first media document and loading for playback of a second media document on the media playback device:
updating the playlist pointer to identify the second media document as the currently-playing media document; and
updating the browsing history list to include a reference to the first media document as the most recently accessed content document.

15. A media playback device for playing media documents in a media browsing session, the device including:
a media playlist including a reference to at least one media document available for playback on the device and a playlist pointer identifying a currently-playing media document in the playlist;
a browsing history list including references to zero or more content documents previously accessed in the media browsing session; and
means for maintaining the media playlist; and
means for maintaining the browsing history list,
wherein said maintaining means are configured to, in response to termination of playback of a first media document and loading for playback of a second media document, update the playlist pointer to identify the second media document as the currently-playing media document, and update the browsing history list to include a reference to the first media document as the most recently accessed content document.

16. A media playback device according to claim 15 which is configured to terminate playback of the first media document and load the second media document for playback when the first media document plays to completion, wherein the second media document is the next media document referenced in the playlist.

17. A media playback device according to claim 15 further including a playlist display having a list of media documents included in the playlist, and means to enable a user to select a new media document from the playlist, wherein the device is configured to terminate playback of the first media document and load the new media document selected by the user as the second media document.

18. A media playback device according to claim 17 wherein the means for selecting a new media document from the playlist includes “next” and “previous” controls.

19. A media playback device according to claim 15 wherein the first media document includes at least one embedded mark-up element providing an active link to the second media document, and the media playback device includes a media display configured to enable a user to select and activate the active link, the device being configured to terminate playback of the first media document and load the second media document for playback responsive to said activation.

20. A media playback device according to claim 19 wherein the embedded mark-up element is a CMML mark-up element.

21. A media playback device according to claim 19 wherein the active link is a hyperlink.

22. A media playback device according to claim 19 wherein the active link is displayed on the media display during playback as a clickable region of the display.

23. A method according to claim 15 wherein, in the event that the playlist does not include a reference to the second media document, the means for maintaining the media playlist is configured to add a reference to the second media document to the playlist.

24. A media playback device according to claim 15 wherein the playlist is a recursive playlist including a hierarchy of sub-lists in which each sub-list is associated with a parent media document at the next higher level of the hierarchy, and the playlist display of the media playback device includes a hierarchical playlist display in which each sub-list is visually associated with its corresponding parent media document in the form of a collapsible list.

25. A media playback device according to claim 24 which is configured such that the sequence of media documents played by the device during continuous playback corresponds with the visible document listing in the hierarchical playlist display.

26. A media playback device according to claim 24 including “next” and “previous” controls to enable a user to select a new media document from the playlist, wherein the media playback device is configured such that activation of said controls result in playback of the next or previous media document in the visible document listing in the hierarchical playlist display respectively.

27. A media playback device according to claim 15 wherein the history list is implemented as a stack, and the means for maintaining the browsing history is configured to update the browsing history list to include a reference to the first media document by pushing a reference to the first media document onto the stack.

28. A media playback device according to claim 15 which is further configured to enable a user to request playback of a previous media document in the media browsing session and, responsive to said request, to retrieve a reference to the first media document from the browsing history list, and to update the playlist pointer to identify the first media document as the currently-playing media document.

29. A media playback device according to claim 27 which is further configured to enable a user to request playback of a previous media document in the media browsing session and, responsive to said request, to retrieve a reference to the first media document from the browsing history list, and to update the playlist pointer to identify the first media document as the currently-playing media document and wherein the step of retrieving a reference to the first media document from the browsing history list includes popping the reference back off the stack.

30. A computer program product including computer-executable instruction code which, when executed on a media playback device, causes the device to effect the steps of a method in accordance with claim 1.

31. A computer program product according to claim 30 wherein the computer-executable instruction code is an extension or plug-in to a standard web browser.

32. A media playback device including a media browser having a media playlist which includes a reference to at least one media document available for playback on the device, and a browsing history list including references to zero or more content documents,
wherein the media browser is configured, responsive to browsing and playback activity of a user during a media browsing session, to perform integrated updates of the media playlist and browsing history list such that the user is provided with a consistent media browsing and playback experience.

33. A media playback device according to claim 32 which includes a first pair of complementary user controls for navigating the media playlist, and a second pair of complementary user controls for navigating the browsing history list, whereby the media browser is configured to perform integrated updates of the media playlist and browsing history list responsive to activation by the user of one or more of said user controls.

34. A media playback device according to claim 33 wherein the first pair of complementary user controls includes “next” and “previous” controls, and the second pair of complementary user controls includes “forward” and “back” controls.

35. A media playback device according to claim 32 wherein said at least one media document includes a media document having embedded metadata elements which mark the beginning of predetermined segments within the media document.

36. A media playback device according to claim 35 wherein the media document including embedded metadata elements is formatted according to the Annodex format.
